(19) United States
(12) Patent Application Publication
(10) Pub. No.: US 2024/0184922 A1
(43) Pub. Date: Jun. 6, 2024

(54) Obscuring Objects and Faces in Shared Streaming Sessions

(71) Applicant: Meta Platforms Technologies, LLC, Menlo Park, CA (US)

(72) Inventors: Eric HAMMERLE, Kirkland, WA (US); Vikramaditya DANGI, San Francisco, CA (US)

(21) Appl. No.: 18/408,952

(22) Filed: Jan. 10, 2024

Related U.S. Application Data
(60) Provisional application No. 63/495,843, filed on Apr. 13, 2023.

(51) Int. Cl. G06F 21/62; G06T 19/00; G06V 10/70; G06V 20/20; G06V 20/40; G06V 40/16

(52) U.S. Cl. CPC G06F 21/6254; G06T 19/00; G06V 10/70; G06V 20/20; G06V 20/41; G06V 40/172; G06T 2219/024

(57) ABSTRACT

Aspects of the present disclosure are directed to obscuring objects and faces in data streams using machine learning. A data stream captured at a client device associated with a user can be processed to recognize objects in the data stream. Based on user preferences that define object sharing rules, one or more of the recognized objects can be obscured from the data stream. For example, when user's data stream is displayed to other users, such as during a video broadcast, objects in the user's data stream can be obscured. User preferences and object sharing rules can be defined using a preview of the data stream and explicit input from the user with respect to recognized objects in the preview. Other example user preferences and sharing rules include rules for recognized faces, rules relative to an object's location in the data stream, rules or objects in motion, etc.

### CROSS-REFERENCE TO RELATED APPLICATION(S)

This application claims priority to U.S. Patent Provisional Application No. 63/495,843 filed on Apr. 13, 2023, titled “Obscuring Objects and Faces in Shared Streaming Sessions” and which is herein incorporated by reference in its entirety.

### BACKGROUND

The pace of technology has increased the world's connectivity. For example, audio connections, such as phone calls, have evolved into audio and video connections, such as video calls. These deeper connections present new challenges, such as privacy concerns and more generally issues that relate to user control over the aspects of the streaming session that are shared. Further, technology's progression towards increased connectiveness continues through artificial reality and other frontiers. Conventional systems fail to address user concerns for sharing and privacy in this increasingly connected environment.

### BRIEF DESCRIPTION OF THE DRAWINGS

FIGS. 1A and 1B are conceptual diagrams illustrating obscuring an object in a field of view of a data capturing device.

FIG. 2 is a flow diagram illustrating a process used in some implementations for receiving user preferences that define how to display objects in data streams.

FIG. 3 is a flow diagram illustrating a process used in some implementations for obscuring people and objects in data streams using machine learning.

FIG. 4 is a block diagram illustrating an overview of devices on which some implementations of the present technology can operate.

FIG. 5 is a block diagram illustrating an overview of an environment in which some implementations of the present technology can operate.

### DETAILED DESCRIPTION

Aspects of the present disclosure are directed to a data stream processing system for obscuring people and objects in data streams using machine learning. Conventionally, data streams can be captured at a client device, such as by a camera connected to an Internet connected client device. These data streams (e.g., a video stream) can then be shared with other users/client devices, such as through a video broadcast, video call, online game (e.g., massively multi-play online game), artificial reality session, or other sharing medium. Using a captured video stream as an example, the video stream may include aspects of the user's surroundings (e.g., strangers, personal information of others, etc.) and/or aspects of the user's social life (e.g., guests, guests' personal items, etc.).

Implementations define user preferences for objects and/or faces shared in data streams so that a user can actively control aspects that are shared and preserve the privacy of others captured in the user's data stream. In the video stream example, user preferences can be defined for objects using input from the user relative to a preview displayed to the user prior to initiating the shared video stream. The user preferences can include explicit definitions from the user, such as the selection of specific objects and/or recognized faces via the displayed preview, and sharing rules for these objects/faces (e.g., explicit permit or obscure rule definitions, etc.). In other examples, the user can define object sharing rules relative to: the field of view of the camera(s) (e.g., display central object and/or object of focus and obscure other objects), object motion (e.g., display objects that are not in motion and obscure objects that are in motion), a social graph of the user (e.g., display recognized faces of connections to the user and obscure other faces), and other suitable sharing rules.

Implementations obscure recognized objects in data streams based on the definitions in the user preferences. For example, a shared stream processor can compare objects in a captured client data stream to user preferences and defined sharing rules. In another example, machine learning model(s) can be used to recognize objects in a client data stream, and the shared stream processor can compare the recognized objects to the user preferences and defined sharing rules. Based on the comparison, recognized objects can be displayed or obscured in the shared data stream.

In some implementations, the defined user preferences include rules for sharing recognized objects. For example, a list of objects permitted for display (e.g., allowlist) and/or a list of object that should not be displayed (e.g., blocklist) can be defined in the user preferences. In another example, a rule can include a predefined region (e.g., region of the captured video) in which objects should be displayed and outside of which objects should not be displayed. The shared stream processor can compare any suitable user preferences and defined sharing rules (e.g., sharing rules for recognized faces, objects in motion, object types, etc.) to objects within a client data stream to select one or more objects to be obscured.

Obscuring an object in some implementations can include blocking, blurring, filtering the objects visual display when the video stream is displayed to others (e.g., broadcast), using a machine learning model (e.g., GAN), to erase the object as if it had never been in the frame, etc. Given the video broadcast example, the field of view of a camera on a user's device may capture the faces of surrounding people, however these faces can be obscured (e.g., blacked out, blurred, erased, or otherwise filtered) based on the user's object sharing rules when the user's video stream is broadcast. If the object sharing rules define that an object should not be displayed in a shared data stream, the shared stream processor can obscure the object by overlapping the object's location with a blocking object, field, or mask, blurring or obstructing the object by applying a filter over its location, or can otherwise obscure the object using its location. In some implementations, obscuring an object includes tracking the object (via one or more trained machine learning models) and dynamically applying the obscuring technique (e.g., filter, blocking object, mask, etc.) based on the tracking.

In some implementations, one or more machine learning models may automatically identify objects to obscure and/or may automatically obscure or erase identified objects. For example, machine learning model(s) may be trained to detect copyrighted or trademarked objects or content, and, when detected, the shared stream processor can obscure or erase these objects or this content. In another example, machine learning model(s) may be trained to detect obscene or adult objects or content, and, when detected, the shared stream processor can obscure or erase these objects or this content.

In some implementations, the obscuring or erasing of object(s) and/or content can occur “on-the-fly” as the camera(s) capture the video. For example, machine learning model(s) can process the data stream and obscure objects/content in real-time. Accordingly, any version of the data stream stored to memory and/or transmitted to other users over a network will include the obscured objects, thus enforcing the user's privacy settings in a reliable manner.

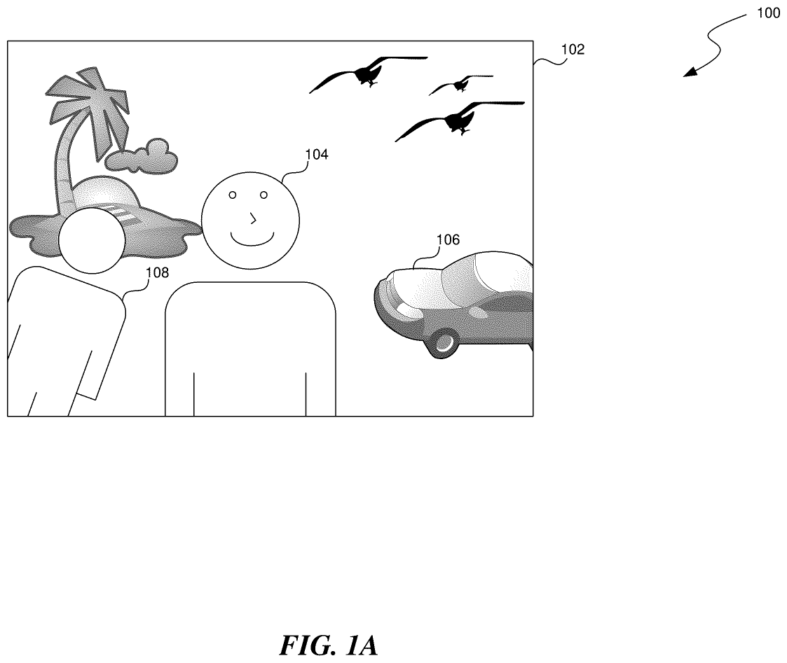

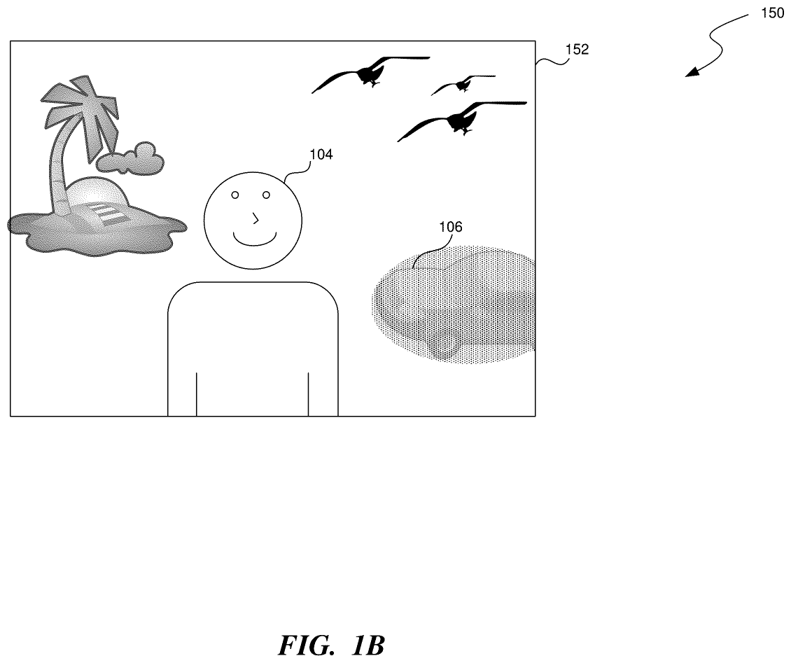

FIG. 1A is a conceptual diagram 100 illustrating a field of view of a data capturing device. Diagram 100 includes captured data stream 102, user 104, object 106, person 108 in a beach setting. For example, one or more image capturing devices can be pointed at user 104 such that object 106 and person 108 are included in captured data stream 102 of the image capturing devices. In some implementations, user 104 can provide input that represents the user's object sharing rules for a shared streaming data session with respect to captured data stream 102.

For example, a preview can be displayed for user 104 with a processed version of captured data stream 102. The preview can include indicators (e.g., outlines) around object 106 and around person 108 that indicate that these items are recognized objects in captured data stream 102. User 104 can select an individual object and provide input that includes object sharing rules that control how the objects are displayed in a shared streaming data session. For example, user 104 may select object 106, illustrated as a motor vehicle, and provide input that the object should not be erased from a shared streaming data session. As a result, in a resulting field of view 152 shown in the conceptual diagram 150 of FIG. 1B, object 106 is obscured during the shared data session (here shown as a gradient pattern to represent blurring). In some implementations, user preferences and object sharing rules can apply to features of an object. For example, user 104 may provide input that defines that objects that include text or numbers (e.g., alphanumeric characters) should be obscured in shared data sessions.

In some implementations, one or more machine learning models can apply facial recognition to person 108 to resolve the person's identity. For example, facial recognition models can compare person 108's face to known images of people (e.g., connections form a user's social graph, images the user selects for facial recognition purposes, etc.). In this example, person 108's identity can be resolved and displayed alongside person 108 in the preview. The user can then select person 108 and define user preferences for sharing this specific person in a shared data session (e.g., share this person's face, obscure this person's face, etc.). The user can also define a general rule for a group of people, such as: erase any person whose identity cannot be resolved by the machine learning models, obscure any person's face that is further than two connections from me on a social graph (e.g., more distant than friends of friends), display any person's face that is connected to me on a social graph, etc. In this example, user 108 is not recognized, causing the system to apply a GAN that erases the person 108 from the resulting field of view 152, while filling in the portion of the frame 152 that had been obscured by the person 108.

In some implementations, multiple people other than user 104 can be displayed in the preview, and the user can selectively define which people (e.g., faces) to display and which people (e.g., faces) to obscure. User 104 can define a rule that applies specifically to the recognized face of user 104. For example, user 104 can define a rule that states the face of user 104 is always displayed during shared data sessions.

In some implementations, user 104 can provide input that adds one or more of objects in the preview to a whitelist, or a list of objects permitted to be displayed in a shared streaming data session. In this example, the specific object is permitted for display, and each object in the list of objects can be stored with specific object definitions. For example, the specific object definitions can include physical characteristic(s) for the object and/or a location for the object. The physical characteristic for the object can include object size, object color, or other suitable physical characteristics. The object size can be a general object size (e.g., extra small, small, medium, large), a determined object size (e.g., determined size in a given unit, such as pixel size, estimated real-world size, and the like), or any other suitable object size. Object color can be the object's primary color or a list of colors. As a result, during a shared streaming data session objects can be recognized and associated with a stored object definition. For example, when a permitted list is applied, only the objects put on the permitted list by user 104 may be displayed and other objects will be obscured.

One or more machine learning model(s) can process the data stream to recognize objects present in the stream (e.g., by performing image recognition/object recognition functionality) and a stream process engine can compare recognized locations and/or physical characteristics of the recognized objects to the specific object definitions stored in the permitted list. Recognized objects found on the list can be displayed unobscured while recognized objects not found on the list can be obscured. This implementation provides a fail safe for unexpected circumstances, such as people or other objects entering captured data stream 102 during a video broadcast in a public setting. These unexpected objects can be obstructed, and thus the privacy of others in the public setting can be maintained.

In some implementations, embodiments of machine learning models can be neural networks with multiple input nodes that receive data streams (e.g., streaming video from one or more cameras, a sequence of images, and the like) as input. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer,”) one or more nodes can produce a value for the input that, once the model is trained, can be used to derive meaningful information from the data streams, generate augments for the data stream, and/or perform other suitable data processing for the data streams. For example, a sequence of images (e.g., streaming video) can be processed to recognize objects, determine object characteristics (e.g., object category, object size, object color), track objects, and/or generate augments that alter the display of the sequence of images (e.g., generate a blocking element, mask, and/or filter to obscure an object). In some implementations, some neural networks, known as deep neural networks, can have multiple layers of intermediate nodes with different configurations, can be a combination of models that receive different parts of the input and/or input from other parts of the deep neural network, or are convolutions or recurrent—partially using output from previous iterations of applying the model as further input to produce results for the current input.

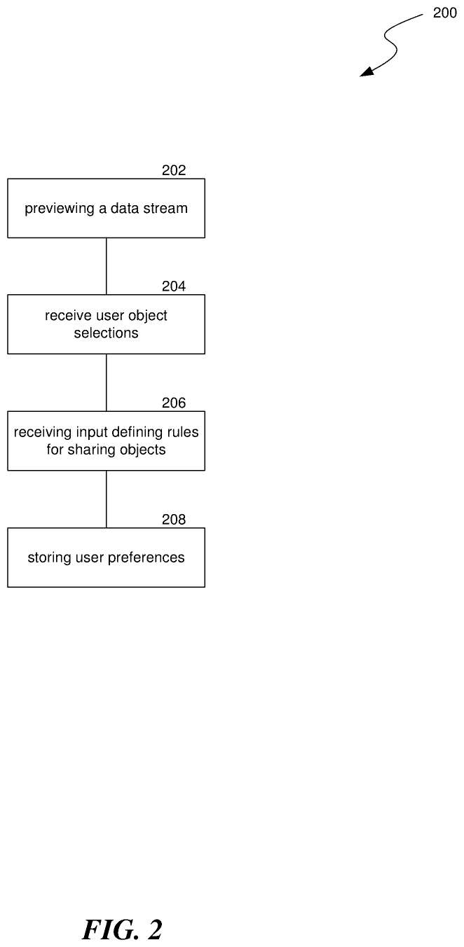

FIG. 2 is a flow diagram illustrating a process used in some implementations for receiving user preferences that define how to display objects in data streams. In some implementations, process 200 can be used to define object sharing rules for a shared streaming data session. Process 200 can be triggered by the initiation of a shared streaming data session or prior to a shared streaming data session. In various implementations, process 200 can be performed on a client device that provides a preference selection user interface to a user and/or can be performed on a server system that supports such a client device (e.g., for remote processing of streaming data).

At block 202, process 200 can display a preview of a data stream to a user. For example, the preview can be a video stream prior to broadcasting and/or recording the video stream. The preview can include objects, such as physical objects and/or people. At block 204, process 200 can receive user object selections. For example, a user can select objects using the preview of the data stream. The objects (e.g., physical objects, people, etc.) can be selected on a preview user interface that displays a captured data stream via one or more cameras, as illustrated by diagram 100 of FIG. 1.

At block 206, process 200 receives input defining rules for sharing the selected objects. For example, object sharing rules for the selected objects can be defined by the input. The object sharing rules define whether the objects are displayed in a shared streaming data session or are obscured in the session.

Some implementations may include a rule that defines a list of permitted objects, such as a list of specific objects with specific object definitions predetermined for display in a shared stream (e.g., an allowlist). In this example, the user's object selection can be used to generate the list of permitted objects for display in a shared streaming data session, and any objects not on the list can be obscured. Some implementations may include a rule that defines a list of restricted objects, such as a list of specific objects with specific object definitions predetermined to not be displayed in a shared stream (e.g., a blocklist). In this example, the user's object selection can be used to generate the list of restricted objects for display in a shared streaming data session, and any objects on the list can be obscured. In some implementations, each selected object presented to the user has a specific object definition (e.g., determined by machine learning model(s)) and the selected object can be stored in the list with its specific object definition.

In another example, the objects selected by the user can be within a defined region, such as a predefined region or volume of space within the preview. The user can then define object sharing rules for objects located within the region and outside the region. In this example, the user can define that objects located within the region can be displayed in a shared streaming data session while objects located outside the region should not be displayed (e.g., should be obscured).

In some implementations, a selected object can be a person, and one or more machine learning models can resolve an identity for the person. For example, facial recognition models can compare the captured person to known images of people (e.g., connections form a user's social graph, images the user selects for facial recognition purposes, etc.). In this example, the person's identity can be resolved and displayed alongside the person object in the preview. The user can then select the person object and define user preferences for sharing the specific person in a shared data session (e.g., share this person's face, obscure this person's face, etc.). The user can also define a general rule for a group of people, such as: obscure any person's face whose identity cannot be resolved by the machine learning models, obscure any person's face that is further than two connections from me on a social graph (e.g., more distant than friends of friends), display any person's face that is connected to me on a social graph, etc.

At 206, process 600 can store the defined object sharing rules as user preferences. For example, the stored user preferences can be accessed when a shared streaming data session (e.g., video broadcast, XR session, and the like) is initiated to control object sharing during the session.

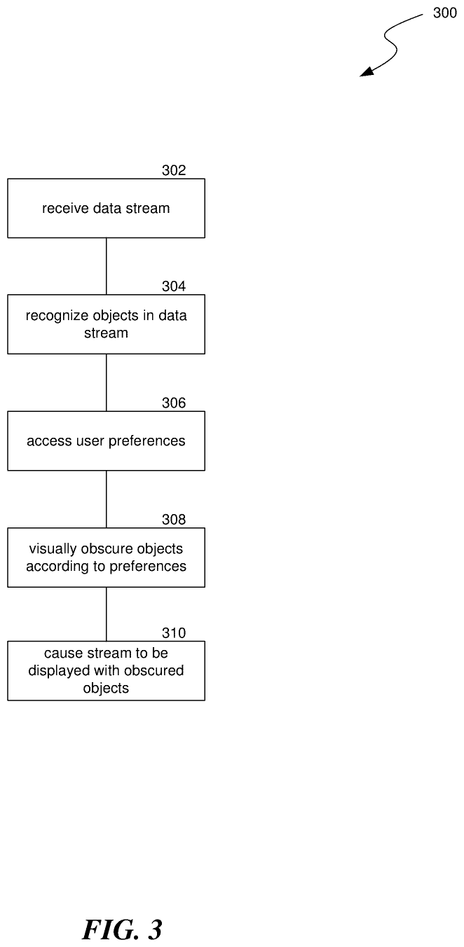

FIG. 3 is a flow diagram illustrating a process used in some implementations for obscuring people and objects in data streams using machine learning. In some implementations, process 300 can be used to control object sharing during a streaming data session for objects captured by an image capturing device associated with a user. Process 300 can be triggered by the initiation of a shared streaming data session. Process 300 can be performed on a client device of a user sending a data stream, on a client device of a user receiving a data stream, or on an intermediate server facilitating communication between such client devices.

At 302, process 300 can receive a data stream. For example, one or more image capturing devices (e.g., cameras) of a client system (e.g., artificial reality (XR) system, personal computing device, and the like) can capture data in a field of view that includes several objects. In some implementations, the received data stream can be part of a shared streaming data session, such as a video broadcast, video call, XR session, or other suitable shared streaming data session.

At 304, process 300 can recognize and categorize objects within the data stream. For example, one or more machine learning models can be trained and/or configured to recognize objects and categorize the objects in the received data stream.

At 306, process 300 can access user preferences that include object sharing rules. For example, the user can define object sharing rules for objects that appear in the field of view captured by the image capturing device(s) of the client system. Process 200 of FIG. 2 can be used to define object sharing rules.

In some implementations, the object sharing rules can define: specific objects and the display status for these specific objects, an object location (e.g., within or outside a predefined region) and the display status for the object location, an object list of permitted objects (e.g., allowlist) with specific object definitions, an object list of restricted objects (e.g., blocklist) with specific object definitions, display status for people (e.g., specific recognized identities using facial recognition, unrecognized faces, etc.), and any other suitable rules. The recognized and categorized objects can be compared to the object sharing rules and one or more of the objects can be obscured when the object category, object location, or other suitable object parameter matches a rule that states the object should be obscured.

At 308, process 300 can visually obscure objects based on the object sharing rules. For example, at least one object can match a rule that defines the object should be obscured in a shared streaming data session. One or more machine learning models can be trained/configured to track the object during the shared streaming data session (e.g., masking out portions of video frames corresponding to the identified objects) and a blocking object, filter, mask, or other suitable obscuring element can be generated in place of or over the object. In some implementations, one or more faces of people are obscured during the shared streaming data session.

At 310, process 300 can cause the shared data stream to be displayed with the obscured objects. For example, a first user's shared streaming data session can be displayed to a second user and a third user, such as part of a video broadcast or a shared XR session. At the second or third user's client device (e.g., personal computing device, XR device, and the like) the first user's shared streaming data (e.g., streaming video) can be displayed, and the at least one object can be obscured in the display.

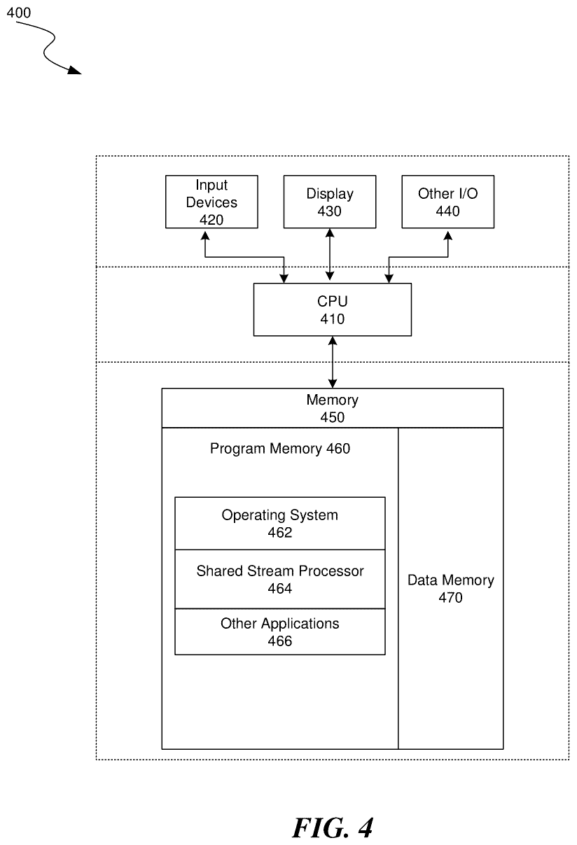

FIG. 4 is a block diagram illustrating an overview of devices on which some implementations of the disclosed technology can operate. The devices can comprise hardware components of a device 400 that obscures people and objects in data streams using machine learning. Device 400 can include one or more input devices 420 that provide input to the Processor(s) 410 (e.g., CPU(s), GPU(s), HPU(s), etc.), notifying it of actions. The actions can be mediated by a hardware controller that interprets the signals received from the input device and communicates the information to the processors 410 using a communication protocol. Input devices 420 include, for example, a mouse, a keyboard, a touchscreen, an infrared sensor, a touchpad, a wearable input device, a camera- or image-based input device, a microphone, or other user input devices.

Processors 410 can be a single processing unit or multiple processing units in a device or distributed across multiple devices. Processors 410 can be coupled to other hardware devices, for example, with the use of a bus, such as a PCI bus or SCSI bus. The processors 410 can communicate with a hardware controller for devices, such as for a display 430. Display 430 can be used to display text and graphics. In some implementations, display 430 provides graphical and textual visual feedback to a user. In some implementations, display 430 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 440 can also be coupled to the processor, such as a network card, video card, audio card, USB, firewire or other external device, camera, printer, speakers, CD-ROM drive, DVD drive, disk drive, or Blu-Ray device.

In some implementations, the device 400 also includes a communication device capable of communicating wirelessly or wire-based with a network node. The communication device can communicate with another device or a server through a network using, for example, TCP/IP protocols. Device 400 can utilize the communication device to distribute operations across multiple network devices.

The processors 410 can have access to a memory 450 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 450 can include program memory 460 that stores programs and software, such as an operating system 462, shared stream processor 464, and other application programs 466. Memory 450 can also include data memory 470, e.g., object definitions, object sharing rules, social graph information, configuration data, settings, user options or preferences, etc., which can be provided to the program memory 460 or any element of the device 400.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

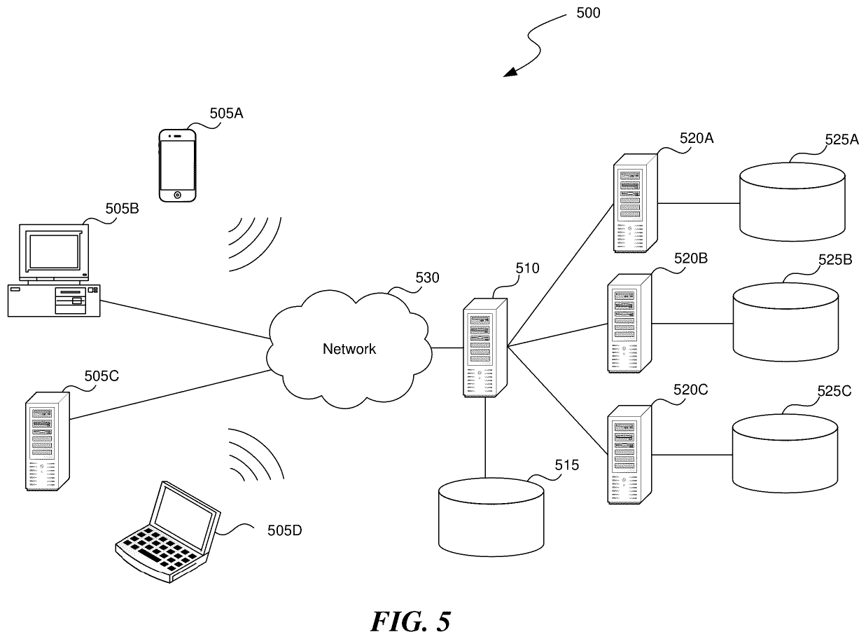

FIG. 5 is a block diagram illustrating an overview of an environment 500 in which some implementations of the disclosed technology can operate. Environment 500 can include one or more client computing devices 505A-D, examples of which can include device 400. Client computing devices 505 can operate in a networked environment using logical connections through network 530 to one or more remote computers, such as a server computing device.

In some implementations, server 510 can be an edge server which receives client requests and coordinates fulfillment of those requests through other servers, such as servers 520A-C. Server computing devices 510 and 520 can comprise computing systems, such as device 400. Though each server computing device 510 and 520 is displayed logically as a single server, server computing devices can each be a distributed computing environment encompassing multiple computing devices located at the same or at geographically disparate physical locations. In some implementations, each server 520 corresponds to a group of servers.

Client computing devices 505 and server computing devices 510 and 520 can each act as a server or client to other server/client devices. Server 510 can connect to a database 515. Servers 520A-C can each connect to a corresponding database 525A-C. As discussed above, each server 520 can correspond to a group of servers, and each of these servers can share a database or can have their own database. Databases 515 and 525 can warehouse (e.g., store) information. Though databases 515 and 525 are displayed logically as single units, databases 515 and 525 can each be a distributed computing environment encompassing multiple computing devices, can be located within their corresponding server, or can be located at the same or at geographically disparate physical locations.

Network 530 can be a local area network (LAN) or a wide area network (WAN), but can also be other wired or wireless networks. Network 530 may be the Internet or some other public or private network. Client computing devices 505 can be connected to network 530 through a network interface, such as by wired or wireless communication. While the connections between server 510 and servers 520 are shown as separate connections, these connections can be any kind of local, wide area, wired, or wireless network, including network 530 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for obscuring people and objects in data streams using machine learning, the method comprising:
recognizing a plurality of objects in a streaming data session using one or more machine learning models, the streaming data session comprising a video stream or a shared artificial reality session, wherein the one or more recognized objects correspond to faces or physical objects;
accessing user preferences that define rules for displaying objects in shared streaming data sessions, wherein the rules define one or more of a) predefined physical objects or user identities permitted for display, b) predefined physical objects or user identities not permitted for display and/or c) an object location and a display status for the object location; and
causing at least one recognized object to be obscured or erased in the streaming data session, wherein the causing is based on applying the defined rules to the recognized objects.

2. The method of claim 1, wherein causing the at least one object to be obscured or erased comprises causing a visual obscuring of the at least one object from display when the streaming data session is displayed, the visual obscuring comprising visual blurring, visual blocking by a displayed obstruction, visual filter, or mask, or a combination thereof.

3. The method of claim 1, further comprising:
performing facial recognition on at least one recognized object to resolve a user identity for the at least one recognized object, wherein the at least one recognized object that is caused to be obscured comprises the resolved object with the resolved user identity, and the at least one recognized object is caused to be obscured based on at least one rule that does not permit the user identity to be displayed.

4. The method of claim 1, further comprising:
displaying, prior to initiating the streaming data session, a preview of the streaming data session, the preview of the streaming data session comprising a preview of captured video or a preview of an artificial reality session;
recognizing, using the one or more machine learning models, a plurality of objects in the preview of the streaming data session;
receiving user input that define a set of rules for displaying the recognized objects during the streaming data session, wherein:
the accessed user preferences that define rules for displaying objects in shared streaming data sessions comprise at least the set of rules, and
the causing the at least one recognized object to be obscured applies at least of one of the set of rules.

5. A system as shown and described herein.

6. A computer-readable storage medium storing instructions that, when executed by a computing system, cause the computing system to perform a process as shown and described herein.
